(19) United States
(12) Patent Application Publication
(10) Pub. No.: US 2010/0015536 A1
(43) Pub. Date: Jan. 21, 2010

(54) PHOTORESIST SOLUTION DISPENSING VOLUME MONITORING SYSTEM AND METHOD THEREOF

(75) Inventors: SHENG CHENG, TAIPEI COUNTY (TW); SHU KUO CHIU, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY (TW)

(21) Appl. No.: 12/243,386

(22) Filed: Oct. 1, 2008

(30) Foreign Application Priority Data
Jul. 18, 2008 (TW) 97127306

(51) Int. Cl. G03C 5/29

(52) U.S. Cl. 430/30

(57) ABSTRACT

A photoresist solution dispensing volume monitoring system comprises: a photoresist solution dispensing apparatus having a photoresist bottle storing photoresist solution; and a weight scale being installed at the circumferential surface of the photoresist bottle, the weight scale measuring the weight of photoresist solution within the photoresist bottle. Via this arrangement, the monitoring system can monitor the practical photoresist solution dispensing volume and the predefined photoresist solution dispensing volume. If the two volumes are not the same, an alarm message will be produced to inform users. So the users can immediately examine or repair the photoresist solution dispensing apparatus. This present invention further provides a photoresist solution dispensing volume monitoring method.

### BACKGROUND OF THE INVENTION

1. Field of the Invention

The present invention is related to a photoresist solution dispensing volume monitoring system and method thereof; in particular, to a photoresist solution dispensing volume monitoring system and a photoresist solution dispensing volume monitoring method used in semiconductor manufacturing processes.

2. Description of Related Art

In semiconductor manufacturing processes, each lot of wafers needs to go through multiple fabrication processes to be made into semiconductor devices, and each step in the manufacturing processes influences the yield of created semiconductor devices; therefore, in each step it is required to strictly control its fabrication process parameters and tool operation. It is particularly important for certain critical processes, such as photoresist solution dispensing.

Photoresist solution dispensing is usually accomplished by means of a photoresist solution dispensing apparatus. The said photoresist solution dispensing apparatus has a photoresist bottle, a pump, and a nozzle, wherein the pump sucks out the photoresist solution held in the photoresist bottle, transfers it into the nozzle, then the nozzle dispenses the acquired photoresist solution onto a wafer surface spinning at high speed. Due to the action of centrifugal force generated when wafer spins, the photoresist solution on the wafer surface starts to move from the center toward the wafer's circumference, allowing a photoresist layer of uniform thickness to be formed on the wafer surface.

However, in practice, sometimes a problem may occur in the aforementioned well-known photoresist solution dispensing apparatus, wherein the photoresist solution volume actually dispensed onto the wafer is less than the prescribed volume, resulting in poor quality in the photoresist layer formed on the wafer surface (i.e. uneven or insufficient thickness in the photoresist layer), and poor photoresist layer tends to reduce the yield of the semiconductor devices.

For an even more severe situation, users may not be able to notice the occurrence of abnormality in the photoresist solution dispensing apparatus in a timely manner, but continue to use the photoresist solution dispensing apparatus with abnormal conditions, further undesirably lowering the yield of the semiconductor devices, thus resulting in significant impact on entire throughput of the semiconductor manufacturing factory.

Accordingly, the present inventors have considered the aforementioned improvable defects and thereby proposed the present invention with reasonable design and effectiveness in resolving the above-said disadvantages.

### SUMMARY OF THE INVENTION

The principal objective of the present invention is to provide a photoresist solution dispensing volume monitoring system and method thereof, which monitors whether the actually dispensed volume of photoresist solution by the photoresist solution dispensing apparatus is consistent to a prescribed volume.

To achieve the above-mentioned objective, the present invention provides a photoresist solution dispensing volume monitoring system, comprising: a photoresist solution dispensing apparatus having a photoresist bottle, wherein the photoresist bottle stores photoresist solution; and a weight scale, being installed at the circumferential surface of the photoresist bottle, and used to measure the weight of the photoresist solution in the photoresist bottle.

The present invention additionally provides a photoresist solution dispensing volume monitoring method, comprising the following steps: providing a weight scale, and placing a photoresist bottle of a photoresist solution dispensing apparatus on the weight scale; measuring the weight of photoresist solution in the photoresist bottle by using the weight scale; activating the photoresist solution dispensing apparatus, outputting photoresist solution in the photoresist bottle according to a prescribed volume and dispensing on a wafer; calculating the reduced weight of photoresist solution in the photoresist bottle, and determining an actually reduced volume of photoresist solution in the photoresist bottle by the calculated reduced weight; and comparing the actually reduced volume of photoresist solution with the prescribed volume to determine the consistency between the two volumes.

The present invention provides the following beneficial effects:

The present invention is allowed to timely generate an alarm signal to remind users in case of occurrence of inconsistency between the actually reduced volume of photoresist solution in the photoresist bottle and the prescribed dispensing volume of the photoresist solution dispensing apparatus, such that users may perform checks or maintenance on the photoresist solution dispensing apparatus, further avoiding formation of photoresist layer with poor quality on more wafer surfaces.

In order to further comprehend the characteristics and technical contents of the present invention, references are made to the detailed descriptions of the present invention and appended drawings thereof; whereas, the appended drawings are simply for purposes of reference and illustration, rather than being used to restrict the scope of the present invention.

### BRIEF DESCRIPTION OF THE DRAWINGS

FIG. 1 is a diagram of the photoresist solution dispensing volume monitoring system according to the present invention;

FIG. 2 is a flowchart of the photoresist solution dispensing volume monitoring method according to the present invention;

FIG. 3 is a flowchart of a second embodiment of the photoresist solution dispensing volume monitoring method according to the present invention.

### DETAILED DESCRIPTION OF PREFERRED EMBODIMENTS

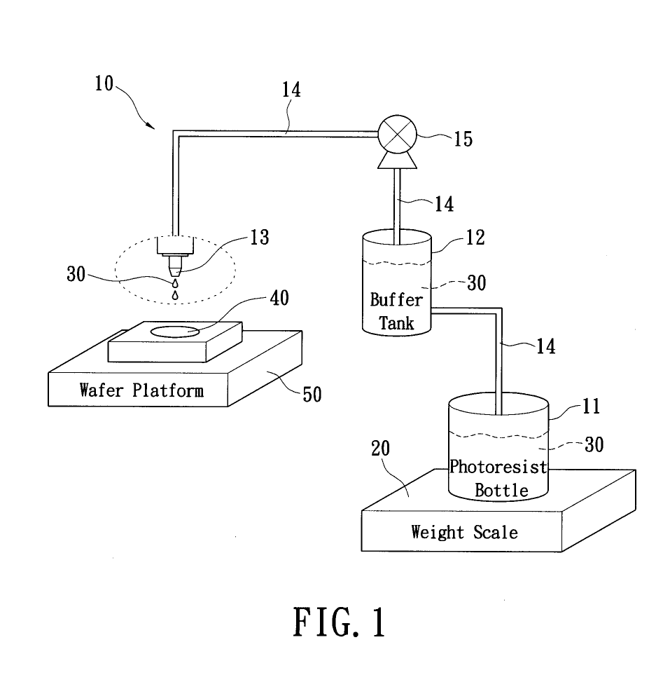

Refer now to FIG. 1, wherein a diagram of the photoresist solution dispensing volume monitoring system according to the present invention is shown, comprising: a photoresist solution dispensing apparatus 10 and a weight scale 20.

The photoresist solution dispensing apparatus 10 includes a photoresist bottle 11, a buffer tank 12, a nozzle 13, and a pump 15, wherein the photoresist solution dispensing apparatus 10 is used to dispense photoresist solution 30 onto a surface of a wafer 40.

The photoresist bottle 11 has a barrel-shaped structure, which stores photoresist solution 30 therein. The photoresist solution 30 is not restricted, but may be of a positive photoresist material or of a negative photoresist material. The photoresist bottle 11 is connected to the buffer tank 12 via a pipe 14. The structure of the buffer tank 12 is similar to the photoresist bottle 11, which presents a hollow shape. The buffer tank 12 is also alternatively connected to the pump 15 through another pipe 14, in which the other end of the pump 15 is further connected to the nozzle 13 by way of yet another pipe 14.

Upon the operation of the pump 15, one end of the pump 15 generates suction force, which draws the photoresist solution 30 from the photoresist bottle 11 to the buffer tank 12, and the photoresist solution 30 in the buffer tank 12 is further drawn into the pump 15 for pressurization, and then transferred into the nozzle 13.

A wafer platform 50 is installed beneath the nozzle 13, and the wafer 40 can be placed on the top end of the wafer platform 50. The wafer platform 50 can drive the wafer 40 to spin at high speed. When the nozzle 13 dispenses the photoresist solution 30 onto the surface of the wafer 40, due to the action of centrifugal force generated as the wafer 40 spins, the photoresist solution 30 on the wafer surface flows from the center of the wafer 40 toward the wafer's circumference, allowing the photoresist solution 30 to be uniformly distributed on the surface of the wafer 40.

The descriptions set forth as above is to illustrate the general operation principle and workflow of the photoresist solution dispensing apparatus 10, the functions of the weight scale 20 will now be introduced hereunder.

The weight scale 20 is installed at the lower end of the photoresist bottle 11 (that is, the photoresist bottle 11 is placed on the top end of the weight scale 20), in which the weight scale 20 can measure a weight value which indicates a weight including the weight of the photoresist bottle 11 in itself and the weight of the photoresist solution 30 stored therein.

Upon the operation of the photoresist solution dispensing apparatus 10, as the photoresist solution 30 is drawn from the photoresist bottle 11 and dispensed on the wafer 40 located under the nozzle 13, the weight scale 20 can measure the reduced weight in the photoresist bottle 11. Since the weight of the photoresist bottle 11 in itself can be considered as constant, thus the variation in weight value measured by the weight scale 20 is directly caused by the change in the weight of the photoresist solution 30. From the reduction in weight of the photoresist solution 30, it is possible to determine how much volume of photoresist solution 30 in the photoresist bottle 11 has been actually drawn, wherein the determination is based on the following formula: reduced weight divided by the density of the photoresist solution 30.

Since the weight scale 20 is electrically connected to the photoresist solution dispensing apparatus 10, the weight scale 20 can transfer the measured weight information to the photoresist solution dispensing apparatus 10. The photoresist solution dispensing apparatus 10 can use the received weight information to determine whether or not the actually reduced volume of photoresist solution 30 in the photoresist bottle 11 is consistent to the prescribed volume dispensed onto the wafer 40. If not, then the photoresist solution dispensing apparatus 10 generates an alarm signal. Such an alarm signal indicates abnormality occurs in certain components of the photoresist solution dispensing apparatus 10; for example, the photoresist solution 30 in the photoresist bottle 11 is running out, the pump 15 malfunctions, the pipe 14 ruptures, or the nozzle 13 is blocked.

The said alarm signal can be presented to users by ways of images, sounds, or lights, allowing users to be immediately aware of the occurrence of abnormality in the photoresist solution dispensing apparatus 10, further stopping the operations of the photoresist solution dispensing apparatus 10 for required emergent checks or maintenance.

Furthermore, upon the occurrence of inconsistency between the actually reduced volume in the photoresist solution 30 and the prescribed dispensing volume, the photoresist solution dispensing apparatus 10 may also automatically stop the dispensing operation of the photoresist solution 30, and then generate an alarm signal to remind users of necessary checks or maintenance.

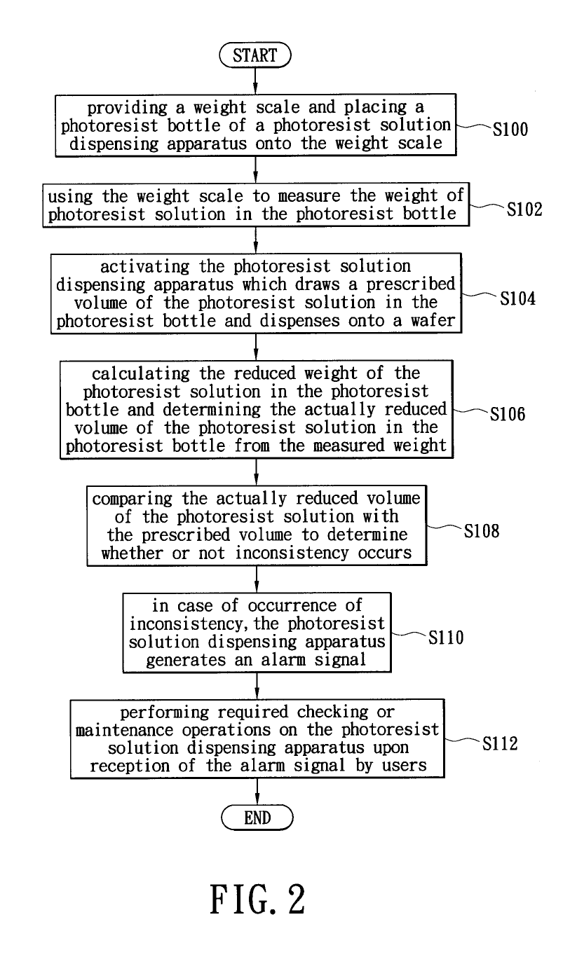

Refer now to FIG. 2 in conjunction with FIG. 1. By means of the aforementioned photoresist solution dispensing volume monitoring system according to the present invention, it is possible to implement a photoresist solution dispensing volume monitoring method, and the monitoring method comprising the following steps:

STEP S100: providing a weight scale 20 and placing a photoresist bottle 11 of a photoresist solution dispensing apparatus 10 onto the weight scale 20.

STEP S102: activating the weight scale 20 and the weight scale 20 measures a weight value which includes the weight of the photoresist bottle 11 in itself and the weight of the photoresist solution 30 in the photoresist bottle 11.

STEP S104: activating the photoresist solution dispensing apparatus 10 which draws a prescribed volume of the photoresist solution 30 in the photoresist bottle 11 and dispenses onto a wafer 40. At this moment, the weight value that the weight scale 20 measures should be reduced.

STEP S106: then calculating the change in weight value measured by the weight scale 20 and determine the actually reduced volume of the photoresist solution 30 in the photoresist bottle 11 from the measured weight value.

STEP S108: next, comparing the actually reduced volume of the photoresist solution 30 with the prescribed volume to determine whether inconsistency occurs.

STEP S110: in case the actually reduced volume of the photoresist solution 30 is inconsistent with the prescribed volume, indicating abnormal situation may have occurred in the photoresist solution dispensing apparatus 10. Therefore, the photoresist solution dispensing apparatus 10 generates an alarm signal to remind users of such a condition, in which the generated alarm signal may be rendered in a form of sound, light, or image.

STEP S112: when users receive the generated alarm signal, it is possible to perform immediately required checking or maintenance operations on the photoresist solution dispensing apparatus 10.

The “consistency” set forth in STEP S108 as above is not to restrict the “actually reduced volume” to be identical to the “prescribed volume”, but a difference within a certain tolerable range can exist between them; for example, a difference between the “actually reduced volume” and the “prescribed volume” may be within a range of 5%, which is still considered as being consistent.

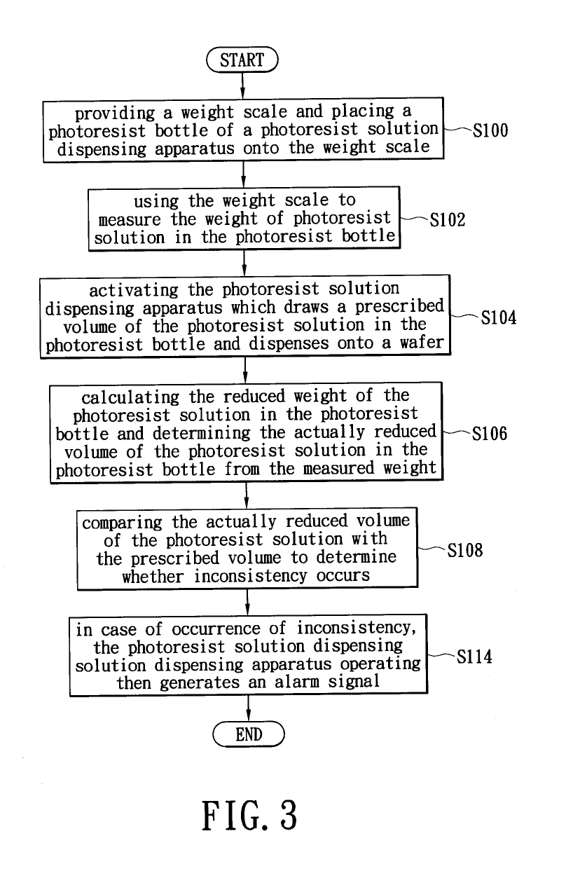

Refer now to FIG. 3, a second embodiment of the photoresist solution dispensing volume monitoring method according to the present invention is shown. The difference between the first and second embodiments lies in the execution step after STEP S108, in which:

STEP S114: if the actually reduced volume of the photoresist solution 30 is inconsistent with the prescribed volume, then the photoresist solution dispensing apparatus 10 automatically stops operating first, then sends an alarm signal.

The monitoring approach taken in the second embodiment can prevent a situation in which users may not be able to arrive at the targeted photoresist solution dispensing apparatus 10 in time and the targeted photoresist solution dispensing apparatus 10 presenting abnormality therein can be refrained from continuing to dispense photoresist solution 30 onto the wafer 40, thereby avoiding possible further impact on the yield of more wafers 40.

The photoresist solution dispensing volume monitoring system and method thereof according to the present invention performs comparison based on the actually reduced “volume” of photoresist solution 30 and the prescribed “volume”; however, it may be performed in accordance with the actually reduced “weight” of photoresist solution 30 and the prescribed “weight” as well.

In summary, the photoresist solution dispensing volume monitoring system and method thereof according to the present invention achieves the following effects:

a. under the situation that the actually reduced volume of the photoresist solution 30 in the photoresist bottle 11 is inconsistent with the volume prescribed to be dispensed, the present invention can timely generate an alarm signal to remind users of such a condition, allowing users to undergo necessary checks or maintenance works on the photoresist solution dispensing apparatus10, further avoiding formation of photoresist layers with poor quality on surfaces of more wafers 40;

b. the monitoring system and method according to the present invention can be conveniently implemented, which only requires to install a weight scale 20 at the circumferential surface of the photoresist bottle 11 of the photoresist solution dispensing apparatus 10, and the cost for the weight scale 20 is affordable;

c. the weight scale 20 may be also used to monitor the residue of the photoresist solution 30 in the photoresist bottle 11, which can calculate how much photoresist solution 30 is still left in the photoresist bottle 11 based on the weight of the photoresist bottle 11 measured by the weight scale 20. In case that the weight of the photoresist bottle 11 measured by the weight scale 20 is lower than a certain value, a remind signal can be also generated, allowing users to supplement the photoresist solution 30 in time.

The aforementioned descriptions simply set forth the preferred embodiments of the present invention, rather than intending to restrict the protected scope of the present application. All equivalently effective changes and modifications made on the basis of the specification and drawings of the present invention are reasonably encompassed by the scope of the present invention defined in the subsequent claim.

What is claimed is:

1. A photoresist solution dispensing volume monitoring system, comprising:
a photoresist solution dispensing apparatus having a photoresist bottle, wherein the photoresist bottle stores photoresist solution; and
a weight scale being installed at the circumferential surface of the photoresist bottle, and used to measure the weight of the photoresist solution in the photoresist bottle.

2. The photoresist solution dispensing volume monitoring system according to claim 1, wherein the weight scale and the photoresist solution dispensing apparatus are electrically connected.

3. The photoresist solution dispensing volume monitoring system according to claim 1, wherein the weight scale is installed at the lower end of the photoresist bottle.

4. The photoresist solution dispensing volume monitoring system according to claim 1, wherein the photoresist solution dispensing apparatus has a buffer tank, and one end of the buffer tank is connected to the photoresist bottle.

5. The photoresist solution dispensing volume monitoring system according to claim 4, wherein the photoresist solution dispensing apparatus has a pump, and one end of the pump is connected to the buffer tank.

6. The photoresist solution dispensing volume monitoring system according to claim 5, wherein the photoresist solution dispensing apparatus has a nozzle, and one end of the nozzle is connected to the pump.

7. The photoresist solution dispensing volume monitoring system according to claim 6, further comprising a wafer platform, wherein the wafer platform is located beneath the nozzle.

8. The photoresist solution dispensing volume monitoring system according to claim 7, wherein a wafer is placed on the wafer platform.

9. The photoresist solution dispensing volume monitoring system according to claim 8, wherein the wafer platform drives the wafer to spin.

10. A photoresist solution dispensing volume monitoring method, comprising the following steps:
providing a weight scale, and placing a photoresist bottle of a photoresist solution dispensing apparatus on the weight scale;
measuring the weight of photoresist solution in the photoresist bottle by using the weight scale;
activating the photoresist solution dispensing apparatus, outputting photoresist solution in the photoresist bottle according to a prescribed volume and dispensing on a wafer;
calculating the reduced weight of photoresist solution in the photoresist bottle, and determining an actually reduced volume of photoresist solution in the photoresist bottle by the calculated reduced weight; and
comparing the actually reduced volume of photoresist solution with the prescribed volume to determine the consistency between the two volumes.

11. The photoresist solution dispensing volume monitoring method according to claim 10, further comprising the following step:
stopping operations of the photoresist solution dispensing apparatus and generating an alarm signal in case that the actually reduced volume of the photoresist solution is inconsistent with the prescribed volume.

12. The photoresist solution dispensing volume monitoring method according to claim 11, wherein the alarm signal is rendered in a form of sound, light, or image.

13. The photoresist solution dispensing volume monitoring method according to claim 11, further comprising the following step:
further checking the photoresist solution dispensing apparatus upon reception of the alarm signal by users.

14. The photoresist solution dispensing volume monitoring method according to claim 10, further comprising the following step:
generating an alarm signal by the photoresist solution dispensing apparatus in case of occurrence of inconsistency between the actually reduced volume of the photoresist solution and the prescribed volume.

15. The photoresist solution dispensing volume monitoring method according to claim 14, wherein the alarm signal is rendered in a form of sound, light, or image.

16. The photoresist solution dispensing volume monitoring method according to claim 14, further comprising the following step:
further checking the photoresist solution dispensing apparatus upon reception of the alarm signal by users.

17. The photoresist solution dispensing volume monitoring method according to claim 10, wherein the actually reduced volume of the photoresist solution and the prescribed volume are considered as consistent when the difference between them is located within a tolerable range.
